(19) United States
(12) Patent Application Publication
(10) Pub. No.: US 2026/0028868 A1
(43) Pub. Date: Jan. 29, 2026

(54) METHOD FOR OPERATING A MOTOR-DRIVEN FLAP ARRANGEMENT OF A MOTOR VEHICLE

(71) Applicant: Brose Fahrzeugteile SE & Co. Kommanditgesellschaft, Bamberg, Bamberg (DE)

(72) Inventors: Sebastian Schoedel, Eckersdorf (DE); Bernd Herthan, Michelau (DE)

(21) Appl. No.: 18/994,874

(22) PCT Filed: Jul. 13, 2023
(86) PCT No.: PCT/EP2023/069477

§ 371 Date: Jan. 15, 2025

(30) Foreign Application Priority Data
Jul. 15, 2022 (DE) 10 2022 117 771.8

(51) Int. Cl. E05F 15/73; B60J 5/10; B62D 33/027; E05F 15/611

(52) U.S. Cl. CPC E05F 15/73; E05F 15/611; B60J 5/101; B62D 33/027; E05Y 2400/36; E05Y 2400/852; E05Y 2900/546

(57) ABSTRACT

A method for operating a flap arrangement of a vehicle. A control arrangement for activating a drive arrangement assigned to the flap arrangement and a radar sensor coupled to the control arrangement are provided. Sensor values relating to an operator and an operator action performed by the operator outside the vehicle are detected by the radar sensor. The detected sensor values are checked by the control arrangement for the fulfilment of predetermined operator action criteria. Depending on the result of the check, the operator action detected via the sensor values is rejected or qualified as a valid operator action, and upon detection of a valid operator action, the drive arrangement is controlled by the control arrangement for the adjustment of the flap arrangement. The detected sensor values can be checked by the control arrangement for a predetermined linger criterion, which represents a lingering of the operator at the flap arrangement.

### CROSS-REFERENCE TO RELATED APPLICATIONS

This application is a national stage application under 35 U.S.C. 371 of International Patent Application Serial No. PCT/EP2023/069477, entitled “Method for Operating a Motor-Driven Flap Arrangement of a Motor Vehicle,” filed Jul. 13, 2013, which claims priority from German Patent Application No. DE 10 2022 117 771.8, filed Jul. 15, 2022, the disclosure of which is incorporated herein by reference.

### FIELD OF THE TECHNOLOGY

Various embodiments relate to a method for operating a motorized flap arrangement of a motor vehicle, a control arrangement for a motorized flap arrangement of a motor vehicle and a flap arrangement of a motor vehicle.

### BACKGROUND

In the known method (DE 10 2017 129 151 A1), on which some embodiments are based, the flap is operated via a predetermined operator action, which can be formed by a foot movement of the operator. An actuation detected as a valid operator action leads to a control of the motorized flap arrangement, so that the operator can open or close the flap, in particular without contact.

### SUMMARY

To increase comfort when operating the flap, it can be advantageous to keep the actuation action to be performed by the operator simple. However, it is a challenge to ensure the detection of operator actions with a high degree of reliability, while at the same time preventing unwanted triggering of the motorized adjustment by movements incorrectly qualified as valid operator actions.

Various embodiments are based on the problem of specifying a method of the type in question that further improves the reliability of detection of operator actions when using radar sensors.

The above problem is solved by various features described herein.

The flap arrangement in question has a motorized adjustable flap. The flap can be any closure element of a motor vehicle. These include tailgates, luggage compartment lids, front cover panels, in particular engine covers, doors, in particular side or rear doors, or the like. The flap can be pivotable or longitudinally displaceable on the vehicle body.

Various embodiments are based on the realization that an undesired triggering of the motorized adjustment can occur due to movements of the operator, which are carried out by the operator while remaining at the flap arrangement. In particular, leg movements of an operator sitting on the vehicle, for example on the loading edge of a tailgate, can lead to false triggering. The fundamental consideration is to detect the operator's lingering position on the basis of the sensor values of the radar sensor and to initiate measures to suppress false triggering.

Specifically, it is proposed that the detected sensor values are checked by means of the control arrangement for a predetermined linger criterion, which represents a linger of the operator at the flap arrangement, and that a suppression mode is adopted by means of the control arrangement when the linger criterion is met, in which the operator action criteria are changed in comparison to a normal mode of the control arrangement.

The signal strength, for example the intensity of the radar signals received, has proven to be a particularly reliable criterion for detecting a lingering of the operator, so that in some embodiments, a signal strength criterion is used to trigger the suppression mode.

Further advantageous variants of the linger criterion are provided herein. Using a distance value criterion, the sensor values representative of short distances in particular can be used and, for example, static objects at a greater distance can be masked out when detecting a lingering operator. It is also possible to use a speed value criterion, which makes it easy to detect an operator who is substantially stationary, in some embodiments.

For a particularly reliable detection of the lingering, a time dependency, in particular the exceeding of a linger time duration, is also taken into account in the sensor values according to various embodiments.

It is also provided in some embodiments to carry out a target tracking routine of radar targets by means of the control arrangement, wherein a radar target trajectory is determined. Consequently, erroneous triggering of the suppression mode, for example by other static objects, can also be ruled out with a high degree of certainty. In some embodiments, a check is carried out to determine whether the radar target first passes through an approach phase.

Various embodiments relate to cancelling or terminating the suppression mode. The termination can be carried out according to some embodiments by cancelling the linger state and/or can be time-controlled.

It is also possible to perform compensation of sensor values after the suppression mode has ended, in particular due to a time lapse. The time lapse can be due to the fact that static objects such as attachments, accessories or the like are placed in the detection range of the radar sensor and remain there. Compensation can avoid a background signal generated by such objects in subsequent measurements.

Likewise, in various embodiments, the termination of the suppression mode can be implemented by the target tracking routine referred to, wherein a renewed removal of the radar target is checked.

In suppression mode, more robust operator action criteria can be used to check the operator action, which is the subject of some embodiments. This means that in suppression mode it is still possible to trigger the motorized adjustment via an operator action, wherein false triggering by the lingering operator is avoided at the same time.

According to further embodiments, a control arrangement for a motorized flap arrangement of a motor vehicle is provided.

It can be that the control arrangement checks the recorded sensor values for a predetermined linger criterion, which represents a lingering of the operator at the flap arrangement, and that the control arrangement assumes a suppression mode when the linger criterion is met, in which the operator action criteria are modified in comparison to a normal mode of the control arrangement. Reference may be made to all explanations of the proposed method.

According to various embodiments, a flap arrangement of a motor vehicle for carrying out the method according to the proposal is provided. Reference may be made to all explanations of the method according to the proposal and the control arrangement according to the proposal.

Various embodiments provide a method for operating a motorized flap arrangement of a motor vehicle, wherein a control arrangement for activating a motorized drive arrangement associated with the flap arrangement and a radar sensor coupled to the control arrangement are provided, wherein sensor values relating to an operator and an operator action performed by the operator outside the motor vehicle are detected by means of the radar sensor, wherein the detected sensor values are checked by means of the control arrangement for the fulfilment of predetermined operator action criteria, wherein, depending on the result of the check, the operator action detected via the sensor values is rejected or qualified as a valid operator action, and wherein, upon detection of a valid operator action, the drive arrangement is controlled by means of the control arrangement for the motorized adjustment of the flap arrangement, wherein the detected sensor values are checked by means of the control arrangement for a predetermined linger criterion, which represents a lingering of the operator at the flap arrangement, and in that a suppression mode is adopted by means of the control arrangement when the linger criterion is met, in which mode the operator action criteria are modified in comparison with a normal mode of the control arrangement.

In various embodiments, the linger criterion contains a signal strength criterion of the detected sensor values. In some embodiments, the signal strength criterion relates to the fulfilment of at least one signal strength threshold value by a signal strength of the sensor values, in particular a spatially integrated signal strength of spatially resolved sensor values.

In various embodiments, the linger criterion contains a distance value criterion of the detected sensor values. In some embodiments, the distance value criterion concerns the undershooting of at least one distance threshold value by distance values contained in the sensor values, and/or in that the linger criterion contains a speed value criterion of the detected sensor values. In some embodiments, the speed value criterion concerns the undershooting of at least one speed threshold value by speed values, in particular Doppler values, contained in the sensor values.

In various embodiments, the linger criterion relates to a time dependence of the detected sensor values. In some embodiments, the linger criterion is at least partially defined in that at least one sub-criterion of the linger criterion, in particular the signal strength criterion, the distance value criterion and/or the speed value criterion, is fulfilled for a predetermined linger period. In some embodiments, the linger criterion is at least partially defined in that at least one sub-criterion of the linger criterion is continuously fulfilled for the linger time period.

In various embodiments, a time-dependent association of detected sensor values to a radar target is carried out by means of the control arrangement in a target tracking routine and a radar target trajectory is determined for the radar target, and in that the linger criterion relates to the radar target trajectory.

In various embodiments, the linger criterion is defined at least in part by the fact that the radar target passes through a predetermined approach phase to the flap arrangement according to the radar target trajectory and then enters a predetermined rest phase after the approach phase.

In various embodiments, the linger criterion, in particular the rest phase, is at least partially defined by the fact that sensor values associated with the radar target maintain the signal strength criterion, the distance value criterion and/or the speed value criterion. In some embodiments, the rest phase is at least partially defined by the fact that sensor values associated with the radar target maintain the signal strength criterion, the distance value criterion and/or the speed value criterion for a predetermined linger period.

In various embodiments, by means of the control arrangement in suppression mode, the detected sensor values are checked for fulfilment of an abort criterion, such as a failure to fulfil the linger criterion, and/or in that, by means of the control arrangement in suppression mode, a time-dependent abort criterion, in particular the expiry of a predetermined suppression period, is checked, and in that the suppression mode is terminated when the abort criterion is fulfilled.

In various embodiments, when the time-dependent abort criterion is fulfilled, rest compensation values of the detected sensor values are determined by means of the control arrangement, and in that the control arrangement is used to check the operator action criteria on sensor values compensated via the rest compensation values.

In various embodiments, the radar target trajectory is checked for passing through a distance phase by means of the control arrangement in suppression mode and the suppression mode is terminated if the distance phase is passed through.

In various embodiments, the operator action criteria are modified in suppression mode in such a way that a probability threshold for qualification as a valid operator action is reduced compared to normal mode, and/or in that at least one parameter for determining an operator action probability of an operator action criterion is modified compared to normal mode. In some embodiments, the at least one parameter relates to a direction of movement and/or a position of the operator action.

In various embodiments, the operator action criteria in suppression mode are modified in such a way that control for motorized adjustment is prevented.

Various embodiments provide a control arrangement for a motorized flap arrangement of a motor vehicle, wherein the control arrangement is set up to control a motorized drive arrangement assigned to the flap arrangement and to couple it to a radar sensor, wherein the radar sensor detects sensor values with respect to an operator and an operator action carried out by the operator outside the motor vehicle, wherein the control arrangement checks the detected sensor values for the fulfilment of predetermined operator action criteria, wherein, depending on the result of the check, the operator action detected via the sensor values is rejected or qualified as a valid operator action, and wherein the control arrangement controls the drive arrangement for the motorized adjustment of the flap arrangement upon detection of a valid operator action, wherein the control arrangement checks the detected sensor values for a predetermined linger criterion, which represents a lingering of the operator at the flap arrangement, and in that the control arrangement assumes a suppression mode when the linger criterion is met, in which the operator action criteria are modified in comparison to a normal mode of the control arrangement.

Various embodiments provide a flap arrangement of a motor vehicle for carrying out a method as described herein.

### BRIEF DESCRIPTION OF THE DRAWINGS

In the following, various aspects are explained in greater detail with the aid of a drawing showing only exemplary embodiments, in which

FIG. 1 shows a perspective view of a rear region of a motor vehicle with a flap arrangement and a control arrangement for carrying out the proposed method.

### DETAILED DESCRIPTION

The proposed method relates to the operation of a motorized flap arrangement 1 of a motor vehicle 2. A control arrangement 3 is used to control a motorized drive arrangement 4 associated with the flap arrangement 1.

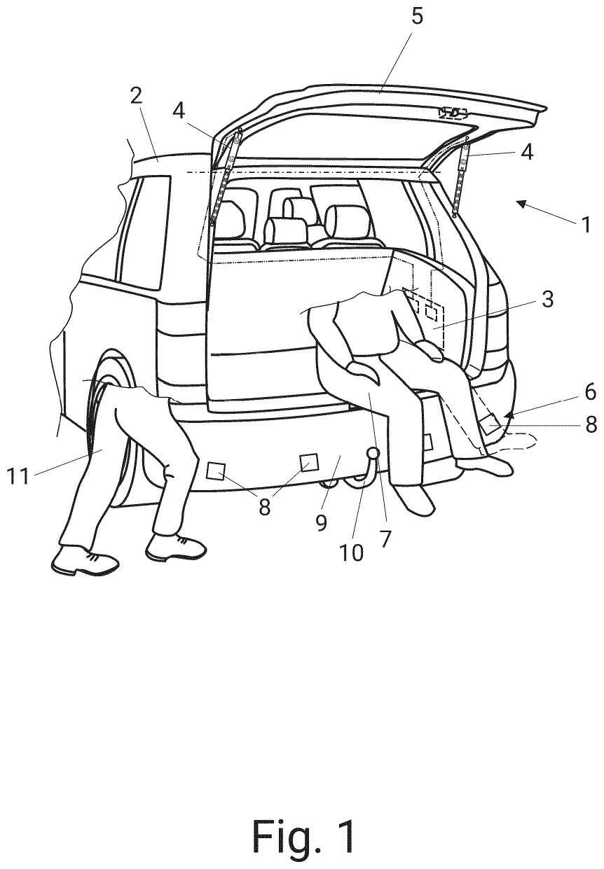

In the illustrated exemplary embodiment, the drive arrangement 4 is provided for moving the flap 5 of the flap arrangement 1 from a closed position (not shown) to the illustrated open position. A transfer of the flap 5 from an open position to a closed position can also be provided. In principle, the drive arrangement 4 can also effect other motorized adjustment functions of the flap arrangement 1, for example unlocking and/or opening of a motor vehicle lock associated with the flap 5. Please refer to the introductory comments for possible configurations of the flap 5, wherein the flap 5 according to the configuration in FIG. 1 is shown here as a tailgate by way of example.

An electronic radar sensor 6 is coupled to the control arrangement 3, wherein sensor values relating to objects outside the motor vehicle 2 are detected by means of the radar sensor 6. The focus here is on the detection of sensor values relating to an operator 7 of the motor vehicle 2 and an operator action performed by the operator 7 outside the motor vehicle 2. An operator action is generally understood to be an action of the operator 7, in particular a movement pattern of a body part of the operator 7 such as an operator gesture.

In some embodiments, the radar sensor 6 has sensor units 8 with respective antenna arrangements, which can be designed with one or more antenna arrays. In particular, the antenna arrays are arranged at a predetermined angle and position relative to one another in order to enable angular resolution of the radar signals. In some embodiments, the radar sensor 6 realizes a continuous, further in some embodiments frequency-modulated, distance measurement and direction measurement, for example as an FMCW radar sensor. The radar sensor 6 can be set up for operation with radar radiation in the frequency band around 24 GHz and/or 77 GHz.

The sensor values are representative of the position of objects outside the motor vehicle 2. For example, the sensor values contain distance information and directional information between the detected object, including the operator 7, and the motor vehicle 2. The sensor values also contain speed information, for example based on Doppler speed values, of the object.

The sensor units 8 can be provided on the flap arrangement 1 so that the operator 7 can carry out the operator action to trigger the motorized adjustment on the flap arrangement 1. In various embodiments, the sensor units 8 are arranged on the rear bumper 9, wherein the operator 7 triggers the adjustment with a predetermined operator action such as a foot movement, such as a kicking movement, in front of the bumper 9.

The recorded sensor values are checked by the control arrangement 3 for compliance with predetermined operator action criteria, wherein the operator action recorded via the sensor values is rejected or qualified as a valid operator action depending on the result of the check. When a valid operator action is detected, the drive arrangement 4 is controlled by the control arrangement 3 for motorized adjustment of the flap arrangement 1.

In a monitoring run, the sensor values are checked here by the control arrangement 3 to ensure that the operator action criteria are met. The operator action criteria can relate to predetermined characteristics of the operator action, for example the position, speed, acceleration of the body part or the like. The recorded sensor values can, for example, be checked for a match with the predetermined characteristics and a degree of similarity or an operator action probability can be determined for the fact that the sensor values are representative of an operator action with the respective characteristic. The operator action probabilities are used to check whether the operator action qualifies as being valid using predetermined criteria.

For example, the (individual) operator action probabilities are weighted using predetermined factors and are incorporated into an overall probability. In particular, a probability threshold can be specified for the overall probability. For an overall probability below the probability threshold, the drive arrangement 4 is not controlled. For an overall probability greater than or equal to the probability threshold, however, the drive arrangement 4 is controlled by means of the control arrangement 3. Individual operator action criteria can also be defined as sufficient or necessary operator action criteria for control and/or operator action probabilities can also be checked individually. Further configurations of the operator action criteria are conceivable.

It is now essential that the recorded sensor values are checked by the control arrangement 3 for a predetermined linger criterion, which represents a lingering of the operator 7 at the flap arrangement 1, and that a suppression mode is adopted by the control arrangement 3 when the linger criterion is met, in which mode the operator action criteria are changed in comparison to a normal mode of the control arrangement 3.

In many cases, a valid operator action is preceded by an approach by the operator 7 immediately beforehand. For example, the operator 7 approaches the tailgate and, after stopping briefly, performs an operator gesture such as a kick movement to open the tailgate.

However, a longer linger time of the operator 7 in the region of the flap arrangement 1, which initially takes place without an operator action, is generally not associated with an actuation intention, so that there is a risk of false triggering. If, for example, the operator 7 is sitting on a loading edge associated with the flap arrangement 1, as shown in FIG. 1, movements such as a swinging of the legs could be incorrectly recognized as a valid operator action. Situations similar to this are longer-lasting activities of the operator 7 in the region of the flap arrangement 1, such as maintenance, repair, cleaning of the motor vehicle 2 and rearranging objects in the load compartment of the motor vehicle 2. Such situations have in common that a movement of the operator 7 could be incorrectly interpreted as a valid operator action.

The suppression mode of the proposed method is therefore aimed at preventing a possible false triggering if an operator 7 lingers, which is achieved by adapting the operator action criteria. Lingering is generally understood to be a behaviour of the operator 7 that is indicative of the operator 7 remaining at the flap arrangement 1 without an actuation request, and which is characterized in particular by a duration that is too long for an actuation request.

Normal mode, on the other hand, represents an operating mode of the control arrangement 3 that is adopted without the operator 7 being present, for example an operating mode with lower requirements for qualification as a valid operator action and consequently with a high probability of detection of operator actions.

In various embodiments, it is provided that the linger criterion includes a signal strength criterion of the detected sensor values, in some embodiments that the signal strength criterion concerns the fulfilment of at least one signal strength threshold value by a signal strength of the sensor values, in particular a spatially integrated signal strength of spatially resolved sensor values.

The signal strength criterion is representative of one or more intensities of the radar signals received by the radar sensor 6. In various embodiments, an energy equivalent is calculated from the sensor values, for example from the magnitude and phase of the radar signals received, as the signal strength, which is incorporated into the signal strength criterion. In a simple embodiment, the signal strength can be compared with a signal strength threshold value.

In the case of spatially resolved sensor values, which can be detected, for example, via the aforementioned use of antenna arrays or several sensor units 8, the signal strength criterion can relate to an integrated signal strength. This means that signal strengths of different detection directions and/or different detection areas are correlated with each other, in particular added together. It is also conceivable that different detection directions and/or different detection areas are weighted and that certain detection directions and/or detection areas are masked out in the assessment of the signal strength criterion.

In various embodiments, the linger criterion contains a distance value criterion of the detected sensor values. In some embodiments, the distance value criterion concerns the undershooting of at least one distance threshold value by distance values contained in the sensor values.

With the distance criterion, objects closer to the flap arrangement 1 can be weighted higher than objects further away from the flap arrangement 1. This approach is based on the realization that the operator 7 is at a short distance from the motor vehicle 2 when remaining there without the intention to operate it. By contrast, objects detected at a greater distance often represent static objects or, for example, an operator 7 who hesitates when approaching with the intention of actuation and then continues to approach.

The distance threshold is used, for example, to ensure that only objects detected in the sensor values below a maximum distance are taken into account in the linger criterion.

In a further embodiment, it is provided that the linger criterion contains a speed value criterion of the recorded sensor values. In some embodiments, the speed value criterion relates to the undercutting of at least one speed threshold value by speed values contained in the sensor values, in particular Doppler values.

The speed values such as the Doppler values can indicate with a high degree of certainty that at least part of the body of the operator 7 remains substantially motionless on the motor vehicle 2. This circumstance can also indicate that the operator 7 is merely lingering, but is not requesting actuation.

Speed values such as the Doppler values can also be determined here using the radar signals without detecting a time dependency. However, it can be that the linger criterion relates to a time dependency of the recorded sensor values.

The linger criterion can be defined at least in part by the fact that at least one sub-criterion of the linger criterion, in particular the signal strength criterion mentioned, the distance value criterion and/or the speed value criterion, is fulfilled for a specified linger period. The linger time is representative of the fact that no actuation request is usually made after it has elapsed. If the operator 7 is substantially motionless in the region of the flap arrangement 1 for the linger time, for example, false triggering can be prevented via the suppression mode.

The at least one sub-criterion does not necessarily have to be fulfilled continuously over the linger time. Rather, the sum of the time durations in which the at least one sub-criterion is fulfilled can also be taken into account via a measurement time interval. However, in some embodiments, it can be that the linger criterion is at least partially defined by at least one sub-criterion of the linger criterion being continuously fulfilled for the linger time duration. In this context, “continuously” means that recorded sensor values fulfil the at least one sub-criterion continuously and without deviation over the linger time period.

Furthermore, in some embodiments, it can be that a time-dependent association of detected sensor values to a radar target is carried out by means of the control arrangement 3 in a target tracking routine and a radar target trajectory is determined for the radar target, and that the linger criterion relates to the radar target trajectory.

Radar targets can be identified in the sensor values, in particular on the basis of the intensity of the reflected radar waves and, in some embodiments, by exceeding a predetermined intensity threshold. In particular, several radar targets detected in the sensor values are combined into a cluster target according to a cluster model. By tracking the radar target over time, a radar target trajectory can be determined, which represents the time dependency of the position of the radar target.

The radar target trajectory can be used to detect a lingering of an operator 7. It can also be provided in some embodiments that the linger criterion is defined at least in part by the fact that the radar target passes through a predetermined approach phase to the flap arrangement 1 in accordance with the radar target trajectory and then enters a predetermined rest phase after the approach phase.

The approach phase can be defined at least in part by the radar target approaching from a predetermined first distance to a predetermined second distance, which is shorter than the first distance. Consequently, it can be ruled out with a high degree of certainty that static objects lead to the suppression mode being triggered, since static objects also lead to a static radar target trajectory. Instead, the target tracking routine and the proximity phase check ensure that the radar target at rest is a moving object and, with a high degree of certainty, an operator 7.

The rest phase can generally be formed by a period of time in which the radar target remains in the region of the flap arrangement 1, wherein reference is made to the above explanations regarding the linger criterion. Furthermore, it can be provided here that the linger criterion, in particular the rest phase, is defined at least in part by the fact that the sensor values associated with the radar target comply with the signal strength criterion, the distance value criterion and/or the speed value criterion, in some embodiments that the rest phase is defined at least in part by the fact that sensor values associated with the radar target comply with the signal strength criterion, the distance value criterion and/or the speed value criterion for a predetermined linger period.

In various embodiments, it is provided that the control arrangement 3 is used in suppression mode to check the recorded sensor values for fulfilment of an abort criterion, such as a failure of the linger criterion being fulfilled, and that the suppression mode is ended when the abort criterion is fulfilled.

If, for example, the linger criterion is defined by a signal strength threshold value being exceeded in a linger time period, the sensor values continue to be checked for exceeding the signal strength threshold value in suppression mode. If the threshold is not exceeded, in particular for a predetermined minimum period of time, the suppression mode can be ended. In some embodiments, the control arrangement 3 then returns to normal mode.

In various embodiments, the control arrangement 3 is used to check a time-dependent abort criterion in suppression mode, in particular the expiry of a predetermined suppression period, and the suppression mode is terminated when the abort criterion is met. This prevents the suppression mode from continuing, for example, if the suppression mode was undesirably triggered by static objects, such as add-on parts attached to the motor vehicle 2, such as a trailer coupling 10 or the like. Accordingly, the suppression duration can be selected to be comparatively long, for example in the order of several hours.

Furthermore, in some embodiments, it can be provided that when the time-dependent abort criterion is met, rest compensation values of the recorded sensor values are determined by means of the control arrangement 3, and that the control arrangement 3 is used to check the operator action criteria on sensor values compensated via the rest compensation values.

The sensor values are compensated here by the rest compensation values, whereby the sensor values are at least partially adjusted for time-varying background signals, such as those caused by static objects like the trailer coupling 10. In a simple case, the rest compensation values represent the “empty signal” of the sensor values in the absence of an operator action and are subtracted from the sensor values for compensation.

In a further embodiment, it is provided that the radar target trajectory is checked by means of the control arrangement 3 in suppression mode for passing through a distance phase and the suppression mode is terminated if the distance phase is passed through.

Consequently, the target tracking routine mentioned can also be used to end the suppression mode. If the radar target, which has led to the suppression mode being triggered by passing through the approach phase and rest phase, for example, leaves the region of the flap arrangement 1 again, it can be assumed that the linger state is cancelled. In this case, the distance phase—in particular the reverse of the approach phase—can be characterized by the fact that the radar target moves from a predetermined first distance to a predetermined second distance, which is greater than the first distance. Target tracking is also used here to ensure that radar signals from other objects next to the operator 7 do not lead to an undesired termination of the suppression mode.

It can also be provided in some embodiments that the operator action criteria in suppression mode are modified in such a way that the aforementioned probability threshold for qualification as a valid operator action is reduced compared to normal mode.

Consequently, stricter requirements are placed on the execution of a valid operator action. For example, the operator action criteria are modified so that a swinging movement of a seated operator 7 can be further differentiated from a kick movement for triggering.

Likewise, at least one parameter for determining an operator action probability of an operator action criterion can be modified in comparison to the normal mode. For example, the aforementioned characteristics of a valid operator action are modified, the factors for considering the individual probability are modified or the like.

The at least one parameter can relate to a direction of movement of the operator action. This can also be used to further differentiate the swinging movement of a seated operator 7 from a kicking movement.

In various embodiments, the at least one parameter can relate to the position of the operator action. If, for example, the suppression mode is triggered by an operator 7 sitting on the loading edge, as in FIG. 1, the sensor values for the detection area in which the operator 7 is located can be suppressed and, in particular, hidden in the evaluation of the operator action. If another person 11 performs an actuation action in a different detection area, this can still be checked for validity.

In a further embodiment, it is provided that the operator action criteria are modified in suppression mode in such a way that control for motorized adjustment is prevented.

This deactivates the triggering of the motorized adjustment by the operator action, so that accidental triggering in the linger state is completely prevented.

A control arrangement 3 for a motorized flap arrangement 1 of a motor vehicle 2 is also proposed, wherein the control arrangement 3 is set up to control a motorized drive arrangement 4 associated with the flap arrangement 1 and to couple it to a radar sensor 6, wherein the radar sensor 6 detects sensor values relating to an operator 7 and an operator action performed by the operator 7 outside the motor vehicle 2, wherein the control arrangement 3 checks the detected sensor values for the fulfilment of predetermined operator action criteria, wherein the operator action detected via the sensor values is rejected or qualified as a valid operator action depending on the result of the check, and wherein the control arrangement 3 controls the drive arrangement 4 for the motorized adjustment of the flap arrangement 1 upon detection of a valid operator action.

It is essential here that the control arrangement 3 checks the recorded sensor values for a predetermined linger criterion, which represents a lingering of the operator 7 at the flap arrangement 1, and that the control arrangement 3 assumes a suppression mode when the linger criterion is met, in which the operator action criteria are modified in comparison to a normal mode of the control arrangement 3.

Reference is made to all comments relating to the proposed method.

A flap arrangement 1 of a motor vehicle 2 for carrying out the proposed method is also proposed. The flap arrangement 1 can include the proposed control arrangement 3, the radar sensor 6 and the motorized drive arrangement 4.

Reference may be made to all the comments relating to the proposed method and the proposed control arrangement 3.

1. A method for operating a motorized flap arrangement of a motor vehicle, wherein a control arrangement for activating a motorized drive arrangement associated with the flap arrangement and a radar sensor coupled to the control arrangement are provided, wherein sensor values relating to an operator and an operator action performed by the operator outside the motor vehicle are detected by the radar sensor, wherein the detected sensor values are checked by the control arrangement for the fulfilment of predetermined operator action criteria, wherein, depending on the result of the check, the operator action detected via the sensor values is rejected or qualified as a valid operator action, and wherein, upon detection of a valid operator action, the drive arrangement is controlled by the control arrangement for the motorized adjustment of the flap arrangement,
wherein the detected sensor values are checked by the control arrangement for a predetermined linger criterion, which represents a lingering of the operator at the flap arrangement, and wherein a suppression mode is adopted by the control arrangement when the linger criterion is met, in which mode the operator action criteria are modified in comparison with a normal mode of the control arrangement.

2. The method according to claim 1, wherein the linger criterion contains a signal strength criterion of the detected sensor values.

3. The method according to claim 1, wherein the linger criterion contains a distance value criterion of the detected sensor values.

4. The method according to claim 1, wherein the linger criterion relates to a time dependence of the detected sensor values.

5. The method according to claim 1, wherein a time-dependent association of detected sensor values to a radar target is carried out by the control arrangement in a target tracking routine and a radar target trajectory is determined for the radar target, and in that the linger criterion relates to the radar target trajectory.

6. The method according to claim 5, wherein the linger criterion is defined at least in part by the fact that the radar target passes through a predetermined approach phase to the flap arrangement according to the radar target trajectory and then enters a predetermined rest phase after the approach phase.

7. The method according to claim 5, wherein the linger criterion is at least partially defined by the fact that sensor values associated with the radar target maintain the signal strength criterion, the distance value criterion and/or the speed value criterion.

8. The method according to claim 1, wherein, by the control arrangement in suppression mode, the detected sensor values are checked for fulfilment of an abort criterion, and/or wherein, by the control arrangement in suppression mode, a time-dependent abort criterion is checked and wherein the suppression mode is terminated when the abort criterion is fulfilled.

9. The method according to claim 8, wherein, when the time-dependent abort criterion is fulfilled, rest compensation values of the detected sensor values are determined by the control arrangement, and wherein the control arrangement is used to check the operator action criteria on sensor values compensated via the rest compensation values.

10. The method according to claim 5, wherein the radar target trajectory is checked for passing through a distance phase by means of the control arrangement in suppression mode and the suppression mode is terminated if the distance phase is passed through.

11. The method according to claim 1, wherein the operator action criteria are modified in suppression mode in such a way that a probability threshold for qualification as a valid operator action is reduced compared to normal mode, and/or wherein at least one parameter for determining an operator action probability of an operator action criterion is modified compared to normal mode.

12. The method according to claim 1, wherein the operator action criteria in suppression mode are modified in such a way that control for motorized adjustment is prevented.

13. A control arrangement for a motorized flap arrangement of a motor vehicle, wherein the control arrangement is set up to control a motorized drive arrangement assigned to the flap arrangement and to couple it to a radar sensor, wherein the radar sensor detects sensor values with respect to an operator and an operator action carried out by the operator outside the motor vehicle, wherein the control arrangement checks the detected sensor values for the fulfilment of predetermined operator action criteria, wherein, depending on the result of the check, the operator action detected via the sensor values is rejected or qualified as a valid operator action, and wherein the control arrangement controls the drive arrangement for the motorized adjustment of the flap arrangement upon detection of a valid operator action,
wherein the control arrangement checks the detected sensor values for a predetermined linger criterion, which represents a lingering of the operator at the flap arrangement, and wherein the control arrangement assumes a suppression mode when the linger criterion is met, in which the operator action criteria are modified in comparison to a normal mode of the control arrangement.

14. A flap arrangement of a motor vehicle for carrying out a method according to claim 1.

15. The method according to claim 2, wherein the signal strength criterion relates to the fulfilment of at least one signal strength threshold value by a signal strength of the sensor values.

16. The method according to claim 3, wherein the distance value criterion concerns the undershooting of at least one distance threshold value by distance values contained in the sensor values, and/or in that the linger criterion contains a speed value criterion of the detected sensor values.

17. The method according to claim 16, wherein the speed value criterion concerns the undershooting of at least one speed threshold value by speed values contained in the sensor values.

18. The method according to claim 4, wherein the linger criterion is at least partially defined in that at least one sub-criterion of the linger criterion, the distance value criterion and/or the speed value criterion, is fulfilled for a predetermined linger period.

19. The method according to claim 18, wherein the linger criterion is at least partially defined in that at least one sub-criterion of the linger criterion is continuously fulfilled for the linger time period.

20. The method according to claim 7, wherein the rest phase is at least partially defined by the fact that sensor values associated with the radar target maintain the signal strength criterion, the distance value criterion and/or the speed value criterion for a predetermined linger period.
